(19) United States
(12) Patent Application Publication
(10) Pub. No.: US 2007/0252785 A1
(43) Pub. Date: Nov. 1, 2007

(54) Plasma display device and processing method thereof

(75) Inventors: Ryo Nakano, Yokohama (JP); Yasuji Noguchi, Yokohama (JP)

Correspondence Address: MCDERMOTT WILL & EMERY LLP, 600 13TH STREET, N.W., WASHINGTON, DC, 20005-3096, US

(73) Assignee: FUJITSU HITACHI PLASMA DISPLAY LIMITED

(21) Appl. No.: 11/703,081

(22) Filed: Feb. 7, 2007

(30) Foreign Application Priority Data
Apr. 27, 2006 (JP) 2006-123983

(51) Int. Cl. G09G 3/28

(52) U.S. Cl. 345/60

(57) ABSTRACT

A plasma display device is provided including: an ambient temperature detector which detects an ambient temperature; a display load factor detector which detects a display load factor; a sustain pulse number determiner which determines a sustain pulse number based on the ambient temperature and the display load factor; and a plasma display panel which performs display according to the determined sustain pulse number.

### CROSS-REFERENCE TO RELATED APPLICATIONS

This application is based upon and claims the benefit of priority from the prior Japanese Patent Application No. 2006-123983, filed on Apr. 27, 2006, the entire contents of which are incorporated herein by reference.

### BACKGROUND OF THE INVENTION

1. Field of the Invention

The present invention relates to a plasma display device and a processing method thereof.

2. Description of the Related Art

The technology development of plasma display panels (PDP) which are self-luminous devices is directed toward a larger screen, with the aim of providing more dynamic display. To further increase the size thereof, weight reduction is one of important problems to be solved.

Generally, a plasma display device provided with a plasma display panel includes a rigid plate-shaped filter supported by tempered glass. This plate-shaped filter is disposed in front of the plasma display panel, with a gap therebetween. The plate-shaped filter has various functions relating to optical characteristics such as an electromagnetic wave shielding function, a near infrared shielding function, and functions of optically adjusting display color and preventing reflection of outside light, and in addition, has a function of protecting the plasma display panel from mechanical shock. However, the plate-shaped filter itself is heavy, which is an undesirable factor in increasing the size of the plasma display panel. A suitable structure to realize weight reduction of the plasma display device is to paste a thin filter supported by a resin film, directly on a front surface of the plasma display panel, instead of assembling the plate-shaped filter (Japanese Patent Application Laid-open No. 2005-234231).

Disposing the plate-shaped filter in front of the plasma display panel is effective to reduce temperature increase of a filter layer ascribable to heat generation of the plasma display panel. This is because air existing between the plasma display panel and the plate-shaped filter insulates heat. On the other hand, inside a casing of the display device, the heat generated by the plasma display panel does not escape, which tends to cause temperature increase of the plasma display panel.

When the temperature of the plasma display panel becomes high, erroneous discharge easily occurs. To prevent the erroneous discharge, it is necessary to take measures against heat such as setting an upper limit of supplied power low or providing a high-performance air-cooling fan.

Another technique to prevent local temperature increase when a panel is under a low load is to monitor a change in the total number of times of discharge and control the total number of times of the discharge toward a decreasing side when the total number of times of the discharge occurs at a predetermined frequency or higher (Japanese Patent Application Laid-open No. 2002-99242).

Pasting a filter in front of a plasma display panel may possibly result in an excessive temperature increase of a filter due to the heat generation of the plasma display panel, if the temperature is controlled in a conventional manner. Therefore, the temperature of a front surface of the filter has to be controlled to be kept at a prescribed value or lower, but the temperature of the plasma display panel and the front surface of the filter are influenced by an ambient temperature. An increase in the ambient temperature also increases the temperature of the front surface of the filter at the same time, and therefore, the total number of times of the discharge has to be controlled based on a state where the ambient temperature is high. However, this has a problem that luminance under a room-temperature environment lowers more than necessary.

An upper limit value of the temperature of the front surface of the filter is decided so as to satisfy the following requirements. (1) From a safety viewpoint, the temperature of the front surface of the filter has to be low enough for a person touching the front surface not to feel a heat shock. Concretely, the temperature has to be about 70° C. or lower. (2) To prevent erroneous discharge, desirably, the temperature of the front surface of the panel does not exceed 80° C. (3) Even when the ambient temperature has an upper limit value of a tolerable operating temperature range (for example, 60° C.), (1) and (2) have to be satisfied.

### SUMMARY OF THE INVENTION

It is an object of the present invention to prevent overheating under a high ambient temperature yet increase luminance under a room-temperature environment.

A plasma display device of the present invention includes: an ambient temperature detector which detects an ambient temperature; a display load factor detector which detects a display load factor; a sustain pulse number determiner which determines a sustain pulse number based on the ambient temperature and the display load factor; and a plasma display panel which performs display according to the determined sustain pulse number.

A processing method of a plasma display device of the present invention includes: detecting an ambient temperature; detecting a display load factor; determining a sustain pulse number based on the ambient temperature and the display load factor; and performing display on a plasma display panel according to the determined sustain pulse number.

### BRIEF DESCRIPTION OF THE DRAWINGS

FIG. 1 is a block diagram showing a configuration example of a plasma display device according to a first embodiment of the present invention;

FIG. 2 is a view showing the structure of the plasma display device;

FIG. 3 is a block diagram of the plasma display device;

FIG. 4 is a conceptual view of subfields in the plasma display device;

FIG. 5 is a chart showing examples of driving waveforms of the plasma display device;

FIG. 6A is a graph showing sustain pulse number and power vs. load factor in the plasma display device according to the first embodiment of the present invention, and FIG. 6B is a graph showing luminance vs. load factor;

FIG. 7 is a graph showing sustain pulse number vs. ambient temperature in the plasma display device;

FIG. 8 is a graph showing temperature of a front surface of a filter vs. ambient temperature in the plasma display device;

FIG. 9 is a graph showing temperature of the front surface of the filter vs. ambient temperature in the plasma display device;

FIG. 10A is a graph showing sustain pulse number and power vs. load factor in a plasma display device according to a second embodiment of the present invention, and FIG. 10B is a graph showing luminance vs. load factor;

FIG. 11 is a graph showing power vs. ambient temperature in the plasma display device;

FIG. 12 is a block diagram showing a configuration example of a plasma display device according to a third embodiment of the present invention;

FIG. 13 is a block diagram showing a configuration example of a plasma display device according to a fourth embodiment of the present invention;

FIG. 14 is a block diagram showing a configuration example of a plasma display device according to a fifth embodiment of the present invention;

FIG. 15 is a block diagram showing a configuration example of a plasma display device according to a sixth embodiment of the present invention;

FIG. 16 is a graph showing a relation between load factor and sustain pulse number;

FIG. 17 is a graph showing a relation between display time and sustain pulse number under a low load factor; and

FIG. 18 is a graph showing a relation between display time and sustain pulse number under a high load factor.

### DETAILED DESCRIPTION OF THE PREFERRED EMBODIMENTS

### First Embodiment

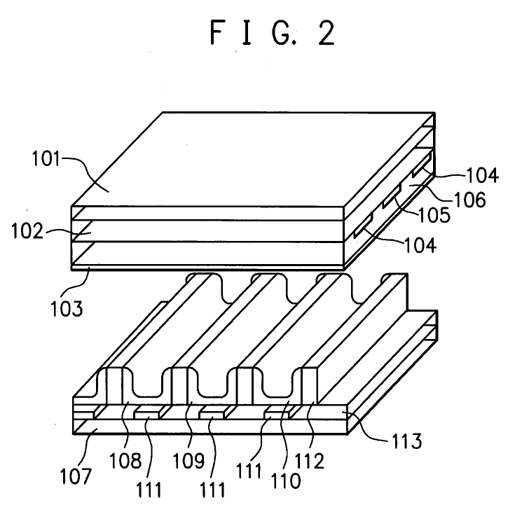

FIG. 2 is a view showing the structure of a plasma display panel mounted on a plasma display device according to a first embodiment of the present invention. As shown in FIG. 2, the plasma display panel is composed of a front plate 102, a filter 101 pasted directly on the front plate 102, a front plate protective layer 103, X electrodes 104, Y electrodes 105, a front-plate-side dielectric layer 106, a rear plate 107, phosphors 108 to 110, address electrodes 111, ribs 112, and a rear-plate-side dielectric layer 113.

On the front plate 102, the X electrodes 104 and the Y electrodes 105 repeating the discharge are arranged in parallel at predetermined spaced intervals. Each of the electrodes makes a pair with an adjacent electrode on one side to discharge, but in some structure, each of the electrodes makes a set with adjacent electrodes on both sides to discharge. Further, the X and Y electrodes are arranged alternately, but in some structure, the X electrodes 104 or the Y electrodes 105 are adjacently disposed on a non-discharge side. This electrode group is covered with the front-plate-side dielectric layer 106, whose surface is further covered with the protective layer 103 of MgO or the like.

On the rear plate 107, the address electrodes 111 are disposed to extend in a substantially perpendicular direction to the X electrodes 104 and the Y electrodes 105, and the address electrodes 111 are covered with the rear-plate-side dielectric layer 113. On both sides of each of the address electrodes 111, the ribs 112 are disposed to separate cells in a column direction. Further, the dielectric layer 113 on the address electrodes 111 and side surfaces of the ribs 112 are coated with the phosphors 108, 109, 110 which emit visible lights of read (R), green (G), and blue (B) when excited by ultraviolet light. The front plate 102 and the rear plate 107 are pasted together, with the protective layer 103 and the ribs 112 being in contact with each other, and discharge gas such as Ne—Xe is sealingly filled, whereby the panel is formed. Incidentally, some structure has ribs separating cells in a row direction.

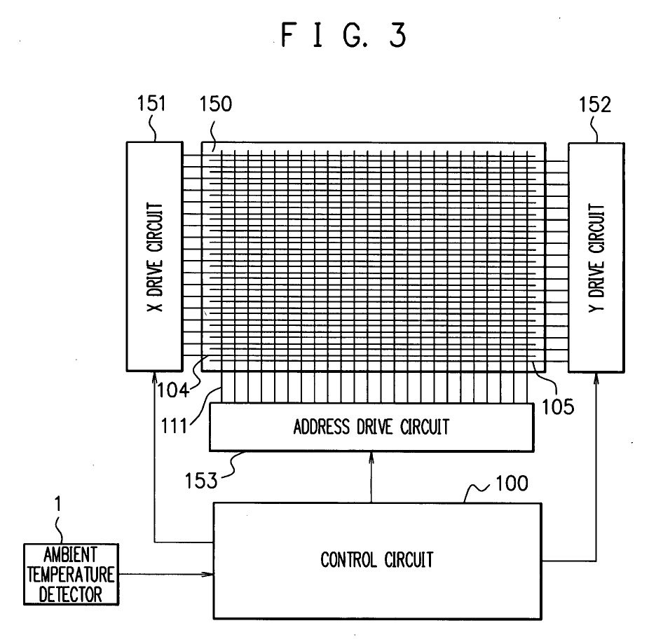

Next, a structure example of the plasma display device of this embodiment will be described with reference to FIG. 3. FIG. 3 shows a plasma display panel (PDP) 150 formed of the front plate 102 and the rear plate 107 pasted together, drive circuits 151 to 153, a control circuit 100, and an ambient temperature detector (temperature sensor) 1. In FIG. 3, the ambient temperature detector 1 which is a temperature sensor is connected to the control circuit 100, and the control circuit 100 is connected to the X drive circuit 151, the Y drive circuit 152, and the address drive circuit 153. Further, the plural X electrodes 104, the plural Y electrodes 105, and the plural address electrodes 111 of the PDP 150 are connected to the X drive circuit 151, the Y drive circuit 152, and the address drive circuit 153, respectively. Incidentally, the address drive circuit 153 is sometimes disposed on each of upper and lower sides of the PDP 150.

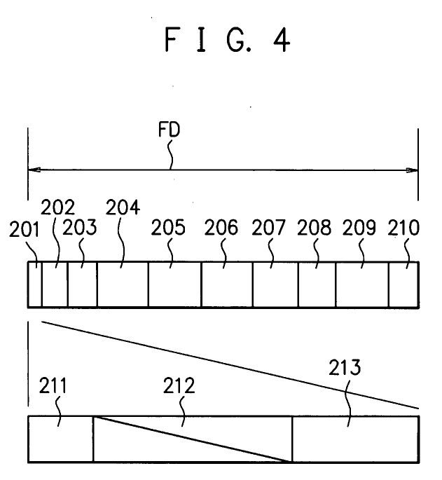

FIG. 4 is a schematic view showing a driving method when one image (1 field: 1/60 sec) is displayed and this driving method is an example of an address and display separated method. One field FD is composed of a plurality of subfields (in this example, 10 subfields 201 to 210). Each of the subfields is composed of a reset period 211, an address period 212, and a sustain period 213. In the reset period 211, charges in cells are controlled for the purpose of assisting the discharge in the subsequent address period 212, and in the address period 212, the discharge for determining a cell for light emission is caused. In the subsequent sustain period 213, the discharge is repeated to cause the cell to emit light.

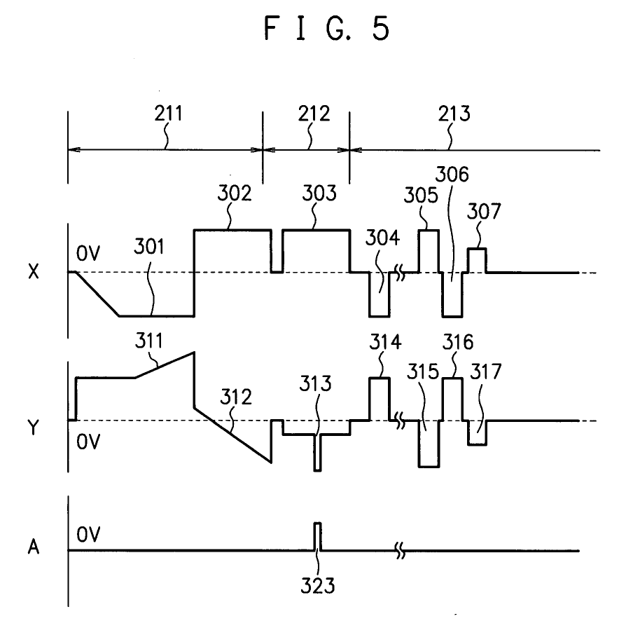

FIG. 5 shows examples of driving waveforms. A waveform X, a waveform Y, and a waveform A are driving waveforms applied to each electrode of the X electrodes 103, the Y electrodes 104, and the address electrodes 111, respectively, during a period from the reset period 211 to the sustain period 213. The waveform X is a voltage waveform applied to the X electrodes 103, the waveform Y is a voltage waveform applied to the Y electrodes 104, and the waveform A is a voltage waveform applied to the address electrodes 111.

First, in the reset period 211, a Y write blunt wave 311 and an X voltage 301 which are to charge all the cells are applied to the X electrodes 103 and the Y electrodes 104 as the waveform X and the waveform Y. Subsequently, a Y compensation blunt wave 312 and an X compensation voltage 302 which are to erase the charges formed in the cells with a required amount thereof being left are applied.

Voltage waveforms applied in the next address period 212 are scan pulse 313 for causing discharge to determine a display cell in a column direction and an X voltage 303 for forming wall charge by this discharge. The scan pulse 313 is applied in sequence column by column at deviated timings. In the display cell, an address pulse 323 is applied to the address electrode 111 in response to the scan pulse 313. Consequently, the discharge occurs between the Y electrode 104 and the address electrode 111, and with this as a pilot flame, discharge occurs between the Y electrode 104 and the X electrode 103, so that the wall charge is generated.

Subsequently, in the sustain period 213, first sustain pulses 304, 314 and repeated sustain pulses 305, 306, 315, 316 are applied. The PDP of this embodiment is of an AC type, and therefore, a set of the discharge pulses with reverse polarity such as the sustain pulses 305, 306, 315, 316 is regarded as one sustain pulse for convenience sake. Finally, erase pulses 307, 317 are applied. In the sustain period 213, only the cell in which the wall charge is generated by the address pulse 323 in the address period 212 discharges and emits light.

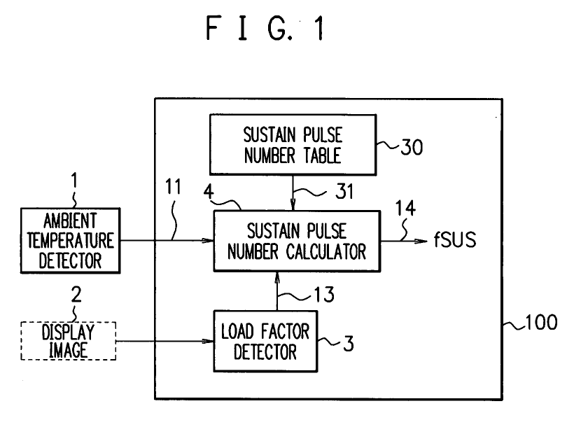

FIG. 1 is a block diagram showing a configuration example of the control circuit 100 of the plasma display device of this embodiment. The ambient temperature detector 1 detects an ambient temperature. Ambient temperature information 11 detected by the ambient temperature detector 1 is sent to a sustain pulse number calculator (sustain pulse number determiner) 4. Further, a load factor detector 3 to which a display image 2 is inputted detects, from the display image 2, a display load factor 13 which is a ratio of the number of lighted cells to the total number of the cells of a screen, and outputs the display load factor 13 to the sustain pulse number calculator 4. Hereinafter, the display load factor will be referred to simply as a load factor. Based on the ambient temperature information 11 and the load factor 13, the sustain pulse number calculator 4 reads, from a sustain pulse number table 30, a sustain pulse number which is such a number that the temperature of a front surface of the filter 101 becomes about 70° C. or lower when the sustain pulse number is set to this number, and outputs an obtained sustain pulse number 14 as a sustain pulse number fSUS which is to be applied to the PDP 150. fSUS is the number of the sustain pulses 305, 306 of the X electrode and the sustain pulses 315, 316 of the Y electrode in FIG. 5.

An example of the ambient temperature detector 1 is a temperature sensor obtaining the temperature of the surroundings of the plasma display device. The temperature sensor or sensors 1 is (are) provided and each of them adopts the highest value in obtained temperature data, an average value of all the temperature data, or an average value of products of the temperature data and coefficients different in values. Consequently, it is possible to prevent the temperature of the front surface of the filter 101 from becoming excessively high.

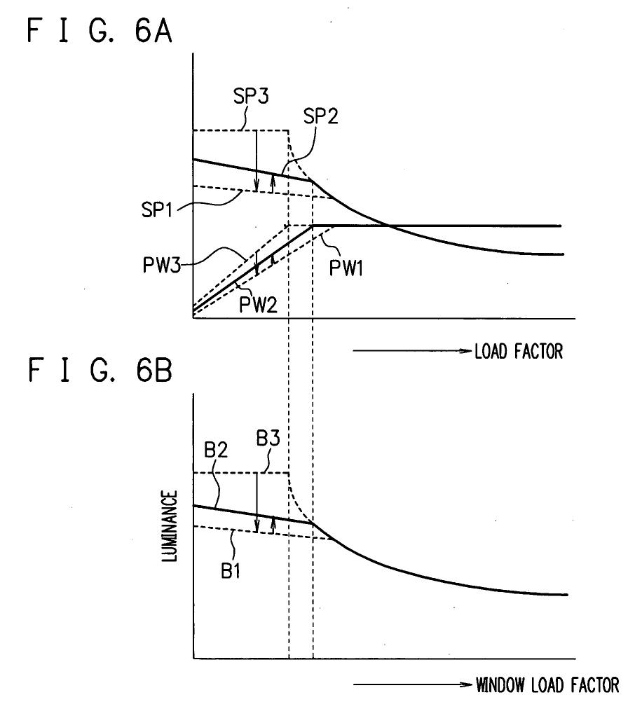

FIG. 6A shows a relation of power and sustain pulse number vs. load factor in the plasma display device, and FIG. 6B shows a relation between window load factor of the maximum gray scale and luminance in the plasma display device. Characteristics SP1 to SP3 show the relation between the load factor and the sustain pulse number. Characteristics PW1 to PW3 show the relation between the load factor and the power. Characteristics B1 to B3 show a relation between the window load factor and the luminance. The characteristic SP1 results in the characteristics PW1 and B1. The characteristic SP2 results in the characteristics PW2 and B2. The characteristic SP3 results in the characteristics PW3 and B3.

As shown by the characteristics SP3 and PW3, when the load factor becomes large, the sustain pulse number SP3 is generally controlled toward a decreasing side so that the power PW3 is kept at a predetermined value or smaller. In accordance with the decrease in the sustain pulse number, the luminance B3 also decreases as shown by B3. The sustain pulse number calculator 4 determines the sustain pulse number SP3 based on the relation in FIG. 6A which is stored in the sustain pulse number table 30 so that the power PW3 has a predetermined value or smaller under the inputted load factor 13.

Another conceivable method to prevent overheating and thermal destruction of the panel is to control the sustain pulse number SP1 toward a decreasing side for a part whose temperature locally becomes the highest even in a low load-factor area, as shown by the characteristics SP1, PW1 and B1. However, if the sustain pulse number SP1 is decreased under the assumption of the worst condition where the ambient temperature is high, the luminance B1 sometimes becomes excessively low even though an effect of inhibiting the temperature increase can be obtained.

In this embodiment, as shown by the characteristics SP2, PW2, and B2, by determining the sustain pulse number based on the load factor 13 and the ambient temperature information 11, it is possible to decrease the sustain pulse number SP2 by an extent necessary to inhibit the temperature increase, which makes it possible to make the luminance B2 relatively high. Consequently, the inhibition of the temperature increase and high luminance can be both realized.

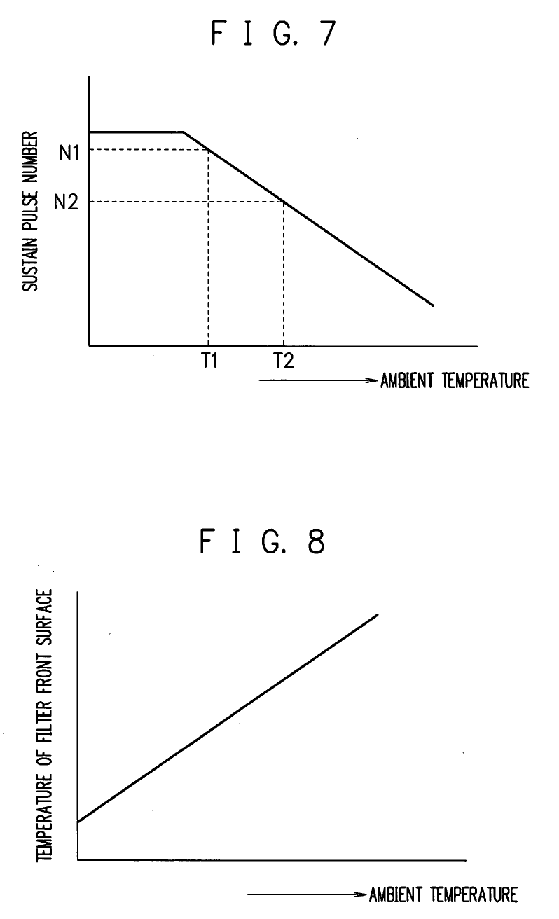

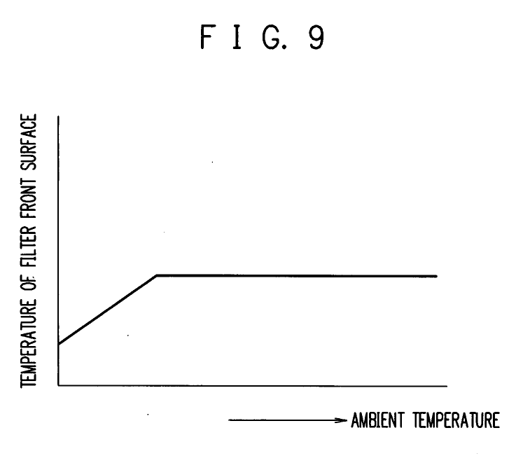

In this embodiment, as shown in FIG. 7, when ambient temperatures T1 and T2 have a relation of T1<T2 under the same load factor, the target sustain pulse number in the control to decrease the sustain pulse number of the low load-factor area is increased/decreased based on the inputted ambient temperature information 11 so that a target sustain pulse number N1 when the ambient temperature is T1 and a target sustain pulse number N2 when the ambient temperature is T2 have a relation of N1>N2. Accordingly, the temperature of the front surface of the filter, which naturally increases with the increase in the ambient temperature information 11 as shown in FIG. 8, can be kept at a predetermined value or lower as shown in FIG. 9. Thus controlling the sustain pulse number based both on the load factor and on the ambient temperature makes it possible to keep high luminance in an approximately room-temperature area yet ensure safety in a high-temperature area.

### Second Embodiment

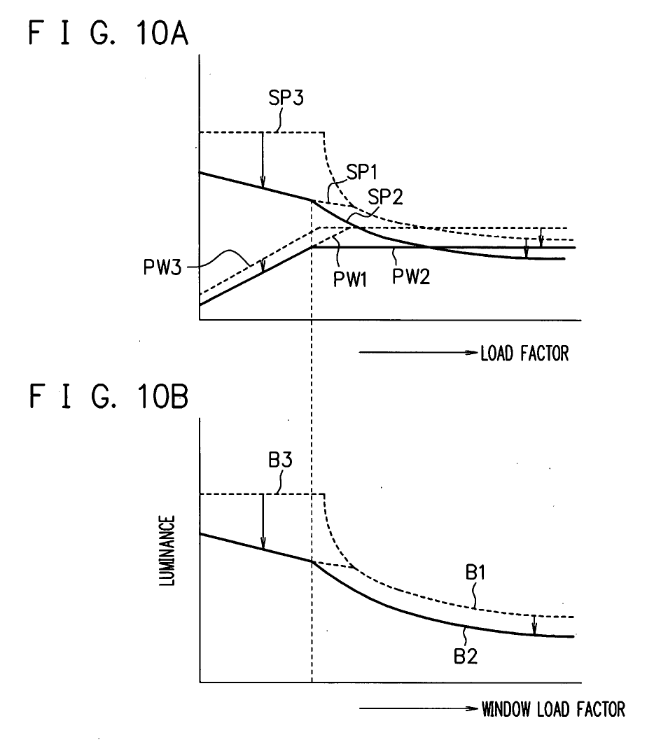

FIG. 10A shows a relation of power and sustain pulse number vs. load factor in a plasma display device according to a second embodiment of the present invention, and FIG. 10B shows a relation between window load factor of the maximum gray scale and luminance in the plasma display device. Characteristics SP1 to SP3 show the relation between the load factor and the sustain pulse number. Characteristics PW1 to PW3 show the relation between the load factor and the power. Characteristics B1 to B3 show the relation between the window load factor and the luminance. The characteristic SP1 results in the characteristics PW1 and B1. The characteristic SP2 results in the characteristics PW2 and B2. The characteristic SP3 results in the characteristics PW3 and B3.

As shown by the characteristics SP3 and PW3, when the load factor becomes large, the sustain pulse number SP3 is generally controlled toward a decreasing side so that the power PW3 is kept at a predetermined value or smaller. In accordance with the decrease in the sustain pulse number, the luminance B3 also decreases. A sustain pulse number calculator 4 determines the sustain pulse number SP3 based on the relation in FIG. 10A which is stored in a sustain pulse number table 30 so that the power PW3 has a predetermined value or smaller under an inputted load factor 13.

Another conceivable method to prevent overheating and thermal destruction of a panel is to control the sustain pulse number toward a decreasing side for a part whose temperature locally becomes the highest in a low load-factor area, as shown by the characteristics SP1, PW1 and B1. However, in some case, the temperature increase has to be inhibited also in a high-load factor area.

In this embodiment, as shown by the characteristics SP2, PW2, and B2, by determining the sustain pulse number based on the load factor 13 and ambient temperature information 11, it is possible to reduce the power PW2 by an extent necessary to inhibit the temperature increase. This can inhibit the temperature increase.

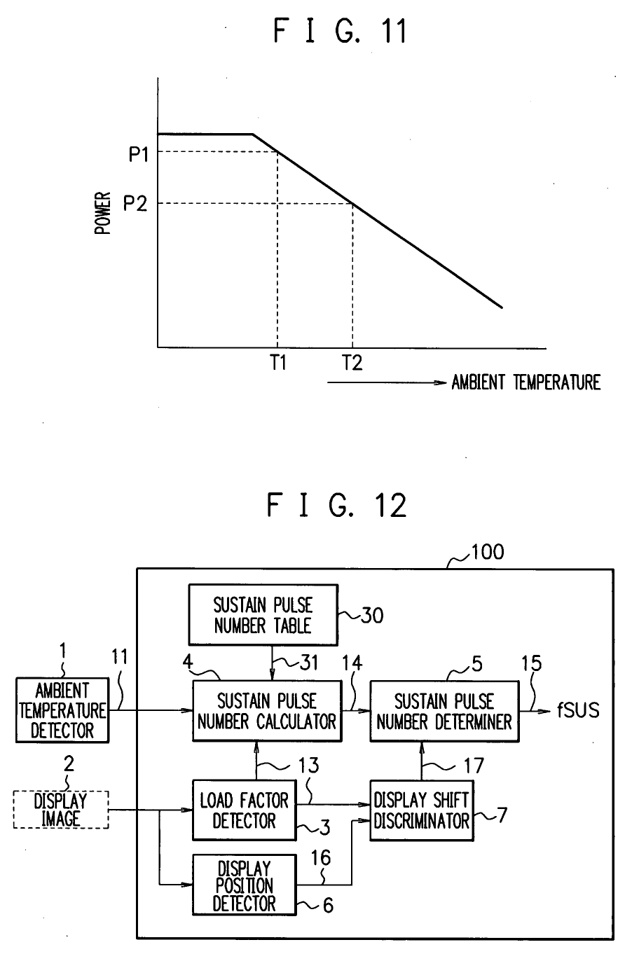

In this embodiment, when ambient temperatures T1 and T2 have a relation of T1<T2 under the same load factor as shown in FIG. 11, target power in the control to decrease the sustain pulse number so that the power is kept at a predetermined value or smaller is increased/decreased based on the inputted ambient temperature information 11 so that target power P1 when the ambient temperature is T1 and a target power P2 when the ambient temperature is T2 have a relation of P1>P2. Thus controlling the sustain pulse number based both on the load factor and on the ambient temperature makes it possible to keep high luminance in an approximately room-temperature area yet ensure safety in a high-temperature area.

### Third Embodiment

FIG. 12 is a block diagram showing a configuration example of a plasma display device according to a third embodiment of the present invention. In this embodiment, the following components are added to the structure of the first embodiment (FIG. 1): a display position detector 6 which detects, from an inputted display image 2, a display position 16 which is a place where a load is concentrated in the image and outputs the display position 16 to a display shift discriminator 7; the display shift discriminator 7 which determines based on a load factor 13 and the display position 16 whether or not the sustain pulse number should be controlled and outputs a determination result as display shift discrimination 17 to a sustain pulse number determiner 5; and the sustain pulse number determiner 5 which determines a sustain pulse number 15 to be finally outputted, based on a sustain pulse number 14 and the display shift discrimination 17 which are inputted from a sustain pulse number calculator 4 and the display shift discriminator 7 respectively.

The display position detector 6 divides the inputted image into a plurality of areas to detect load factors of the respective areas and discriminates an area where the load concentrates. By detecting the display position, it is possible to know whether or not a high load-factor area has shifted. In a case where the high load-factor area is fixedly displayed, the temperature of a front surface of a filter 101 keeps increasing in the display position where the load concentrates, and therefore, the sustain pulse number has to be controlled toward a decreasing side.

Based on the load factor 13 and the display position 16, the display shift discriminator 7 discriminates the kind of load factor and whether or not the image with the load factor has shifted or is fixedly displayed, and outputs the display shift discrimination 17.

Based on the sustain pulse number 14 outputted from the sustain pulse number calculator 4 and the display shift discrimination 17 discriminated by the display shift discriminator 7, the sustain pulse number determiner 5 performs the following control to output the final sustain pulse number 15 as fSUS: to adopt the sustain pulse number 14 as it is in a case where it is determined that the image has shifted, since the temperature increase of a front surface of a filter 101 is small in this case; and to decrease the sustain pulse number 14 in a case where it is determined that the image is fixed. The display shift discriminator 7 is capable of detecting a difference in the display position and outputting the difference as the display shift discrimination 17.

When two values ΔP1 and ΔP2 of a difference ΔP between display positions Pb, Pa (Pa−Pb=ΔP) have a relation of ΔP1>ΔP2 under the same load factor, the target sustain pulse number in the control to decrease the sustain pulse number in a low load-factor area is increased/decreased so that a target sustain pulse number N1 when the difference in the display position is ΔP1 and a target sustain pulse number N2 when the difference in the display position is ΔP2 have a relation of N1>N2. Accordingly, the temperature of a front surface of a filter, which naturally increases with the increase in ambient temperature information 11 as shown in FIG. 8, can be kept at a predetermined value or lower as shown in FIG. 9. Moreover, the control can be relaxed in an image where a high load-factor portion shifts. As a result, it is possible to keep high luminance. Thus controlling the sustain pulse number based on the display position makes it possible to keep high luminance in an approximately room-temperature area yet ensure safety in a high-temperature area.

### Fourth Embodiment

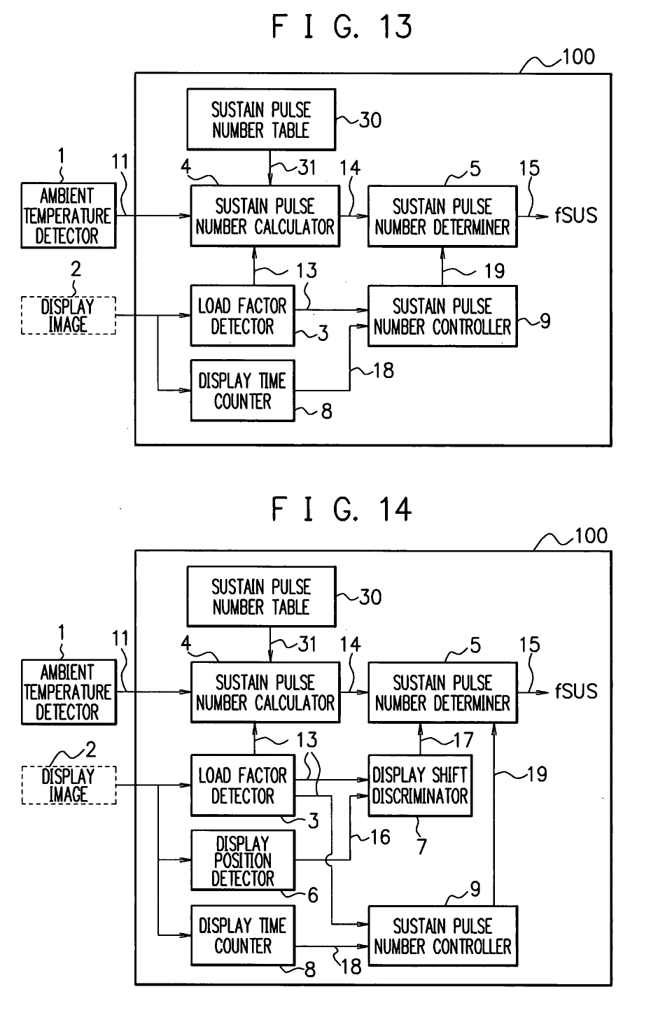

FIG. 13 is a block diagram showing a configuration example of a plasma display device according to a fourth embodiment of the present invention. The structure of this embodiment is different from that of the third embodiment (FIG. 12) in that the display position detector 6 and the display shift discriminator 7 of the third embodiment are replaced by a display time counter 8 and a sustain pulse number controller 9.

An ambient temperature detector 1 detects an ambient temperature to output ambient temperature information 11 to a sustain pulse number calculator 4. The sustain pulse number calculator 4 calculates a sustain pulse number 14 to be outputted, based on a load factor 13, which is detected from a display image 2 by a load factor detector 3, and the ambient temperature information 11.

The display time counter 8 has a function of counting the time regarding each load factor in the display image 2 and can find the kind of each load factor and the number of displayed frames of an image with this load factor within a certain time. That is, the display time counter 8 is a display time detector which detects a display time 18 regarding each load factor. The sustain pulse number controller 9 receives the display time 18 of the image with the load factor 13, and in a case where the display time 18 of the image with the load factor 13 in a prescribed range exceeds a prescribed value, it controls the sustain pulse number toward a decreasing side and outputs a sustain pulse number 19.

The sustain pulse number determiner 5 receives the sustain pulse number 14 outputted from the sustain pulse number calculator 4 and the sustain pulse number 19 outputted from the sustain pulse number controller 9, and determines a final sustain pulse number 15 to output it as fSUS.

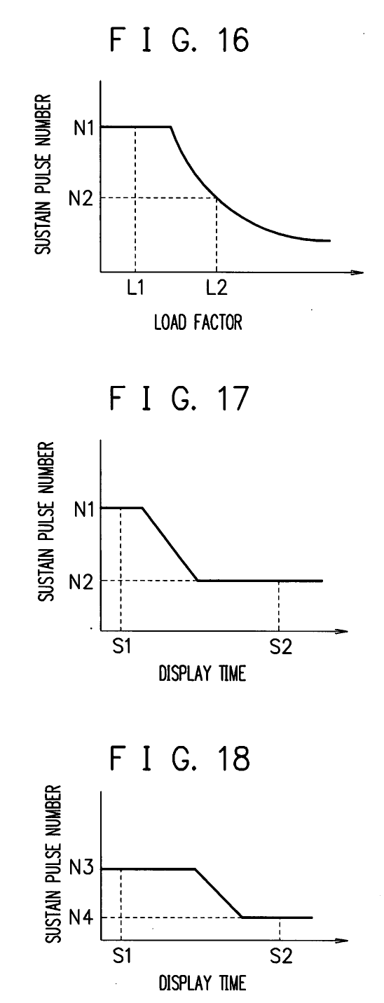

FIG. 16 shows a relation between load factor and sustain pulse number. As described above, the sustain pulse number is controlled according to the load factor so as to adjust power to a predetermined value or smaller. When load factors L1 and L2 have a relation of L1<L2, a target sustain pulse number N1 when the load factor is L1 is larger than a target sustain pulse number N2 when the load factor is L2.

FIG. 17 shows a relation between display time and sustain pulse number under the low load factor L1. When display times S1 and S2 have a relation of S1<S2 under the same load factor L1, the sustain pulse number of a low load-factor area is controlled so that a target sustain pulse number N1 when the display time is S1 and a target sustain pulse number N2 when the display time is S2 have a relation of N1>N2.

FIG. 18 shows a relation between display time and sustain pulse number under the high load factor L2. When the display times S1 and S2 have a relation of S1<S2 under the same load factor L2, the sustain pulse number of a high load-factor area is controlled so that a target sustain pulse number N3 when the display time is S1 and a target sustain pulse number N4 when the display time is S2 have a relation of N3>N4.

The control under the low load factor L1 in FIG. 17 and the control under the high load factor L2 in FIG. 18 are different. In the control under the low load factor L1 in FIG. 17, to inhibit the temperature increase, the decrease of the sustain pulse number needs to be started from the time when the display time is relatively short. In the control under the high load factor L2 in FIG. 18, the decrease of the sustain pulse number only needs to be started from the time when the display time is relatively long. When the display time is shorter than the time up to the start of the control, the sustain pulse number is not decreased, and as a result, it is possible to keep high luminance.

As described above, when the display times S1 and S2 have the relation of S1<S1 under the same load factor, the sustain pulse number is decreased so that the target sustain pulse number N1 when the display time is S1 and the target sustain pulse number N2 when the display time S2 have the relation of N1>N2. Accordingly, the temperature of a front surface of a filter, which naturally increases with the increase in the ambient temperature information 11 as shown in FIG. 8, can be kept at a predetermined value or lower as shown in FIG. 9. Moreover, as compared with a case of the low load factor L1, in a case of the high load factor L2 in FIG. 18, the sustain pulse number is not decreased when the display time is relatively short. As a result, it is possible to keep high luminance. Thus controlling the sustain pulse number based on the display time makes it possible to keep high luminance in an approximately room-temperature area yet ensure safety in a high-temperature area.

### Fifth Embodiment

FIG. 14 is a block diagram showing a configuration example of a plasma display device according to a fifth embodiment of the present invention. In this embodiment, the third and fourth embodiments are performed in parallel, and a display position detector 6, a display shift discriminator 7, a display time counter 8, and a sustain pulse number controller 9 are all provided.

Ambient temperature information 11 detected by an ambient temperature detector 1 is outputted to a sustain pulse number calculator 4. A display image 2 is inputted to a load factor detector 3, the display position detector 6, and the display time counter 8. A load factor 13 detected by the load factor detector 3 is outputted to the sustain pulse number calculator 4, the display shift discriminator 7, and the sustain pulse number controller 9. A display position 16 detected by the display position detector 6 is outputted to the display shift discriminator 7. A display time 18 counted by the display time counter 8 is outputted to the sustain pulse number controller 9. The sustain pulse number calculator 4 reads a sustain pulse number 14 from a sustain pulse number table 30 according to the ambient temperature information 11 and the load factor 13 and outputs the read sustain pulse number 14 to the sustain pulse number determiner 5. Based on the load factor 13 and the display position 16, the display shift discriminator 7 discriminates what kind of load factor exists at which position, and based on a difference in position from a previous frame, it determines whether or not the position with a high load-factor display has shifted and outputs display shift discrimination 17 to the sustain pulse number determiner 5. Based on the load factor 13 and the display time 18, the sustain pulse number controller 9 discriminates how many frames of an image with what kind of load factor continues, and accordingly outputs a sustain pulse number 19 to the sustain pulse number determiner 5. The sustain pulse number determiner 5 receives the sustain pulse number 14, the display shift discrimination 17, and the sustain pulse number 19 and determines a final sustain pulse number 15 to output it as fSUS.

When differences ΔP1 and ΔP2 in the display positions and display times S1 and S2 have a relation of ΔP1>ΔP2 and a relation of S1<S2 respectively under the same load factor, the target sustain pulse number is increased/decreased so that a target sustain pulse number N1 when the difference in the display position is ΔP1 and the display time is S1 and a target sustain pulse number N2 when the difference in the display position is ΔP2 and the display time is S2 have a relation of N1>N2. Accordingly, the temperature of a front surface of a filter, which naturally increases with the increase in the ambient temperature information 11 as shown in FIG. 8, can be kept at a predetermined value or lower as shown in FIG. 9. Moreover, it is possible to relax the control of decreasing the sustain pulse number in an image where a high load-factor portion shifts or a high load-factor display disappears in a short time. As a result, it is possible to keep high luminance. Thus controlling the sustain pulse number based on the display position and the display time makes it possible to keep high luminance in an approximately room-temperature area yet ensure safety in a high-temperature area.

### Sixth Embodiment

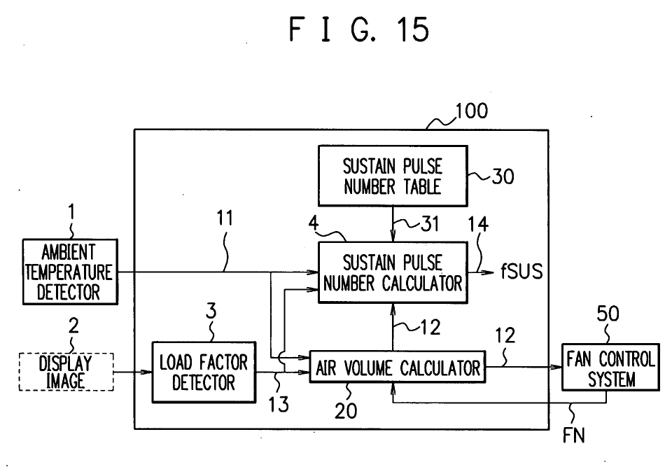

FIG. 15 is a block diagram showing a configuration example of a plasma display device according to a sixth embodiment of the present invention. In this embodiment, a required air volume calculator 20 which calculates a required air volume of a fan control system 50 is added to the first embodiment (FIG. 1), and the required air volume calculator 20 outputs a required air volume 12 to the fan control system 50. The fan control system 50 is intended to cool the plasma display device by sending air and outputs an ON signal FN while in operation.

A sustain pulse number calculator 4 receives ambient temperature information 11 detected by an ambient temperature detector 1 and a load factor 13 detected by a load factor detector 3 and outputs a sustain pulse number 14 as fSUS. The required air volume calculator 20 receives the ambient temperature information 11 outputted by the ambient temperature detector 1, the load factor 13 detected by the load factor detector 3, and the ON signal FN and outputs the required air volume 12 to the fan control system 50 and the sustain pulse number calculator 4. The required air volume calculator 20 outputs the required air volume 12 only while receiving the ON signal FN. According to the ambient temperature information 11, the load factor 13, and the required air volume 12, the sustain pulse number calculator 4 reads a sustain pulse number from a sustain pulse number table 30 and outputs the sustain pulse number 14 as fSUS.

When required air volumes W1 and W2 have a relation of W1>W2 under the same load factor, the target sustain pulse number is increased/decreased so that a target sustain pulse number N1 when the required air volume is W1 and a target sustain pulse number N2 when the required air volume is W2 have a relation of N1>N2. Accordingly, the temperature of a front surface of a filter, which naturally increases with the increase in the ambient temperature information 11 as shown in FIG. 8, can be kept at a predetermined value or lower as shown in FIG. 9. Moreover, it is possible to input the sustain pulse number which is higher by a value corresponding to a decremental amount of the temperature of the front surface of the filter which decreases by the influence of a panel rear surface cooled by the fan control system 50. As a result, it is possible to keep high luminance. Thus controlling the sustain pulse number based on the required air volume 12 of the fan control system 50 makes it possible to keep high luminance in an approximately room-temperature area yet ensure safety in a high-temperature area.

According to the first to sixth embodiments, it is possible to inhibit a temperature increase of the plasma display panel and the front surface of the filter yet increase luminance under a room-temperature environment. Moreover, higher safety and display quality can be achieved in a plasma display device in which a thin filter is pasted directly on a front surface of a plasma display panel.

The filter 101 in FIG. 2 is provided directly on or in front of the front surface of the plasma display panel. According to the first to sixth embodiments, the temperature of the front surface of the filter 101 can be kept not lower than an ambient temperature nor higher than 70° C.

According to the present embodiments, it is possible to inhibit a temperature increase of a plasma display panel yet increase luminance under a room-temperature environment.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A plasma display device comprising:
an ambient temperature detector detecting an ambient temperature;
a display load factor detector detecting a display load factor;
a sustain pulse number determiner determining a sustain pulse number based on the ambient temperature and the display load factor; and
a plasma display panel performing display according to the determined sustain pulse number.

2. The plasma display device according to claim 1,
wherein, when the ambient temperatures T1 and T2 have a relation of T1<T2 under the same display load factor, said sustain pulse number determiner determines the sustain pulse number in a manner that a sustain pulse number N1 when the ambient temperature is T1 and a sustain pulse number N2 when the ambient temperature is T2 has a relation of N1>N2.

3. The plasma display device according to claim 2, further comprising
a display position detector detecting a difference in display position,
wherein, when the differences ΔP1 and ΔP2 in the display position have a relation of ΔP1>ΔP2 under the same display load factor, said sustain pulse number determiner determines the sustain pulse number in a manner that a sustain pulse number N1 when the difference in the display position is ΔP1 and a sustain pulse number N2 when the difference in the display position is ΔP2 have a relation of N1>N2.

4. The plasma display device according to claim 2, further comprising
a display time detector detecting a display time regarding each of the display load factors,
wherein, when the display times S1 and S2 have a relation of S1<S2 under the same display load factor, said sustain pulse number determiner determines the sustain pulse number in a manner that a sustain pulse number N1 when the display time is S1 and a sustain pulse number N2 when the display time is S2 have a relation of N1>N2.

5. The plasma display device according to claim 2, further comprising:
a display position detector detecting a difference in display position; and
a display time detector detecting a display time regarding each of the display load factors,
wherein, when the differences ΔP1 and ΔP2 in the display position have a relation of ΔP1>ΔP2 and the display times S1 and S2 have a relation of S1<S2 under the same display load factor, said sustain pulse number determiner determines the sustain pulse number in a manner that a sustain pulse number N1 when the difference in the display position is ΔP1 and the display time is S1 and a sustain pulse number N2 when the difference in the display position is Δ2 and the display time is S2 have a relation of N1>N2.

6. The plasma display device according to claim 2, further comprising
an air volume calculator calculating an air volume of a fan,
wherein, when the air volumes W1 and W2 have a relation of W1>W2 under the same display load factor, said sustain pulse number determiner determines the sustain pulse number in a manner that a sustain pulse number N1 when the air volume is W1 and a sustain pulse number N2 when the air volume is W2 have a relation of N1>N2.

7. The plasma display device according to claim 1, further comprising
a filter provided directly on or in front of a front surface of said plasma display panel,
wherein a temperature of a front surface of said filter is kept not lower than the ambient temperature nor higher than 70° C.

8. A processing method of a plasma display device comprising:
detecting an ambient temperature;
detecting a display load factor;
determining a sustain pulse number based on the ambient temperature and the display load factor; and
performing display on a plasma display panel according to the determined sustain pulse number.

9. The processing method of the plasma display device according to claim 8,
wherein, when the ambient temperatures T1 and T2 have a relation of T1<T2 under the same display load factor, the sustain pulse number is determined in said determination of the sustain pulse number in a manner that a sustain pulse number N1 when the ambient temperature is T1 and a sustain pulse number N2 when the ambient temperature is T2 has a relation of N1>N2.

10. The processing method of the plasma display device according to claim 9, further comprising
detecting a difference in display position,
wherein, when the differences ΔP1 and ΔP2 in the display position have a relation of ΔP1>ΔP2 under the same display load factor, the sustain pulse number is determined in said determination of the sustain pulse number in a manner that a sustain pulse number N1 when the difference in the display position is ΔP1 and a sustain pulse number N2 when the difference in the display position is ΔP2 have a relation of N1>N2.

11. The processing method of the plasma display device according to claim 9, further comprising
detecting a display time regarding each of the display load factors,
wherein, when the display times S1 and S2 have a relation of S1<S2 under the same display load factor, the sustain pulse number is determined in said determination of the sustain pulse number in a manner that a sustain pulse number N1 when the display time is S1 and a sustain pulse number N2 when the display time is S2 have a relation of N1>N2.

12. The processing method of the plasma display device according to claim 9, further comprising:
detecting a difference in display position; and
detecting a display time regarding each of the display load factors,
wherein, when the differences ΔP1 and ΔP2 in the display position have a relation of ΔP1>ΔP2 and the display times S1 and S2 have a relation of S1<S2 under the same display load factor, the sustain pulse number is determined in said determination of the sustain pulse number in a manner that a sustain pulse number N1 when the difference in the display position is ΔP1 and the display time is S1 and a sustain pulse number N2 when the difference in the display position is ΔP2 and the display time is S2 have a relation of N1>N2.

13. The processing method of the plasma display device according to claim 9, further comprising
calculating an air volume of a fan,
wherein, when the air volumes W1 and W2 have a relation of W1>W2 under the same display load factor, the sustain pulse number is determined in said determination of the sustain pulse number in a manner that a sustain pulse number N1 when the air volume is W1 and a sustain pulse number N2 when the air volume is W2 have a relation of N1>N2.

14. The processing method of the plasma display device according to claim 8,
wherein a temperature of a front surface of a filter, which is provided directly on or in front of a front surface of the plasma display panel, is kept not lower than the ambient temperature nor higher than 70° C.
